(19) United States
(12) Patent Application Publication
(10) Pub. No.: US 2026/0266383 A1
(43) Pub. Date: Sep. 10, 2026

(54) PINCH VALVE SUBASSEMBLY

(71) Applicant: Saban Ventures Pty Limited, Macquarie Park, NSW (AU)

(72) Inventors: Panagiotis THRASOU, St. Marys, NSW (AU); Makamo TSUBONO, Dulwich Hill, NSW (AU); Brett James MONTAGUE, Galston, NSW (AU); David Anthony PIDCOCK, Dulwich Hill, NSW (AU); Amir Hossein KAYVANPOUR, Carlingford, NSW (AU); Danilo Pilapil BATERNA, Marsfield, NSW (AU)

(21) Appl. No.: 19/165,874

(22) PCT Filed: Mar. 19, 2024
(86) PCT No.: PCT/IB2024/052644

§ 371 Date: Sep. 16, 2025

Related U.S. Application Data
(60) Provisional application No. 63/491,199, filed on Mar. 20, 2023.

(51) Int. Cl. F16K 7/07

(52) U.S. Cl. CPC F16K 7/07

(57) ABSTRACT

A pinch valve subassembly includes a cage and a diaphragm disposed within the cage. The diaphragm is configured to sealingly engage the cage. Additionally, the cage includes an opening configured to receive a fluid flow and direct the fluid flow against the diaphragm via the opening to compress the diaphragm and transition the pinch valve subassembly to a closed configuration. The pinch valve subassembly is configured to be disposed within a cavity of a housing in an installed configuration, and the pinch valve subassembly includes a seal surrounding the cage and configured to sealingly engage the housing in the installed configuration.

### CROSS REFERENCE TO RELATED APPLICATION

This application claims priority to and the benefit of U.S. Provisional Patent Application No. 63/491,199, entitled “PINCH VALVE SUBASSEMBLY,” filed Mar. 20, 2023, and incorporated by reference in its entirety for all purposes.

### BACKGROUND

### Technical Field

The present disclosure generally relates to a pinch valve subassembly for use in association with directing a fluid through a conduit system.

### Background

Pinch valves are used to control fluid flow through a conduit system. For example, a pinch valve transitions between an open configuration (e.g., a fully open configuration) to enable fluid flow through a portion of the conduit system and a closed configuration (e.g., a fully closed configuration) to block fluid flow through the portion of the conduit system. The pinch valve can also transition to a configuration between the open configuration and the closed configuration to enable a certain amount, such as a target flow rate, of fluid flow through the conduit system (e.g., a partially open configuration or a partially closed configuration).

### SUMMARY

In one aspect, a pinch valve subassembly is provided. The pinch valve subassembly comprises: an elongate tubular diaphragm; an elongate cage comprising an inner surface configured to be disposed around and face the main body of the elongate tubular diaphragm in a sealing engagement with the elongate tubular diaphragm, wherein the elongate cage has a first end, a second end, and at least one opening extending from an outer surface of the elongate cage between the first end and the second end to the inner surface of the elongate cage; and a seal disposed between the first end and the at least one opening.

In another aspect, a pinch valve subassembly is provided. The pinch valve subassembly comprises: an elongate tubular diaphragm; an elongate cage comprising a first end, a second end, a hole extending from the first end to the second end, and an outer surface extending between the first end and the second end, wherein the hole of the elongate cage is configured to receive the elongate tubular diaphragm such that the elongate cage is disposed around the elongate tubular diaphragm in a sealing engagement with the elongate tubular diaphragm; and at least one opening formed through the outer surface of the elongate cage and extending to the hole of the elongate cage.

In another aspect, a pinch valve subassembly is provided. The pinch valve subassembly comprises: an elongate tubular diaphragm; an elongate cage comprising a first end, a second end, a hole extending from the first end to the second end, and an outer surface extending between the first end and the second end, wherein the hole of the elongate cage is configured to receive the elongate tubular diaphragm such that the elongate cage is disposed around the elongate tubular diaphragm in a sealing engagement with the elongate tubular diaphragm, and wherein the elongate cage is configured to place the elongate tubular diaphragm in longitudinal tension; and at least one opening formed through the outer surface of the elongate cage and extending to the hole of the elongate cage.

In another aspect, a method is provided. The method comprises: coupling an elongate cage around an exterior surface of a main body of an elongate tubular diaphragm to provide a pinch valve subassembly, wherein the pinch valve subassembly comprises at least one opening in the elongate cage exposing the exterior surface of the main body of the elongate tubular diaphragm to fluidically couple the exterior surface of the main body of the elongate tubular diaphragm to an outer surface of the elongate cage, and wherein the pinch valve subassembly comprises a seal that extends beyond the outer surface of the elongate cage; positioning the pinch valve subassembly in an elongate cavity of a housing; and fluidically coupling a fluid source to the at least one opening in the elongate cage.

### BRIEF DESCRIPTION OF THE DRAWING

Embodiments of the present disclosure are described herein in conjunction with the accompanying drawings, in which:

FIGS. 1A and 1B are cross-sectional views of different conduit systems that employ pinch valve subassemblies, in accordance with certain embodiments presented herein;

FIG. 2 is a cross-sectional view of a pinch valve subassembly employed within a conduit system and configured to control fluid flow through the conduit system, in accordance with certain embodiments presented herein;

FIG. 3 is a cross-sectional view of a pinch valve subassembly, in accordance with certain embodiments presented herein;

FIG. 4 is a side view of a diaphragm of a pinch valve subassembly, in accordance with certain embodiments presented herein;

FIGS. 5A and 5B are cross-sectional views of a conduit system that employs a pinch valve subassembly configured to block leakage of fluid flow, in accordance with certain embodiments presented herein;

FIG. 6 is a cross-sectional view of a conduit system that employs pinch valve subassemblies, in accordance with certain embodiments presented herein;

FIG. 7A is a perspective view of another pinch valve subassembly, in accordance with certain embodiments presented herein;

FIG. 7B is a cross-sectional view of the pinch valve subassembly of FIG. 7A;

FIG. 8 is a cross-sectional view of yet another pinch valve subassembly, in accordance with certain embodiments presented herein;

FIG. 9 is a cross-sectional view of still another pinch valve subassembly, in accordance with certain embodiments presented herein;

FIG. 10 is a cross-sectional view of another conduit system that employs a pinch valve subassembly, in accordance with certain embodiments presented herein;

FIG. 11A is a perspective view of yet another conduit system that employs a pinch valve subassembly, in accordance with certain embodiments presented herein;

FIG. 11B is a cross-sectional view of the conduit system of FIG. 11A;

FIG. 12A is a cross-sectional side view of another conduit system that employs a pinch valve subassembly, in accordance with certain embodiments presented herein;

FIG. 12B is a detailed cross-sectional side view of Area A of FIG. 12A; and

FIG. 13 is a flowchart of a method of manufacture of a conduit system, in accordance with certain embodiments presented herein.

### DETAILED DESCRIPTION

Different systems, such as water treatment plants, heating and cooling structures, sanitization systems, and hydraulic circuits, can utilize a conduit system to direct a fluid (e.g., a gas, a liquid, a vapor-gas mixture, etc.). The conduit system can include, for example, a conduit, a pipe, a tube, etc. to transport the fluid to different locations. The conduit system can also include a valve, such as a pinch valve, to control flow (e.g., a flow rate, a flow speed) of the fluid. The pinch valve includes a body that defines an opening through which a fluid can flow. The body can transition between an open configuration, a closed configuration, and/or an intermediate configuration therebetween to adjust flow of the fluid through the body. For example, the body can be composed of a flexible or pliable material, and walls of the body can be compressed toward one another to reduce a size of the opening defined by the body, thereby restricting or blocking fluid flow through the body. The walls of the body can also be moved away from one another to increase the size of the opening, thereby increasing fluid flow through the body.

It is desirable to improve pinch valve designs to facilitate installation of the pinch valve into a conduit system and enable the pinch valve to control fluid flow through the conduit system in a desirable manner. As such, embodiments of the present disclosure are directed to a pinch valve subassembly that is readily insertable into a cavity or recess of a housing of a conduit system. The pinch valve subassembly includes a diaphragm and a cage in which the diaphragm can be inserted. The cage includes an opening that enables flow of a working fluid (e.g., gas) to impart a force onto the diaphragm to transition the diaphragm to a closed configuration.

In accordance with embodiments presented herein, the diaphragm and the cage sealingly engage one another to block undesirable flow of working fluid out of the pinch valve subassembly, thereby forcing the working fluid to flow against the diaphragm to transition the diaphragm to the closed configuration. Additionally, a seal can be coupled to the cage. In an installed configuration of the pinch valve subassembly within the cavity of the conduit system, the seal and the housing sealingly engage one another to block undesirable flow of working fluid between the cage and the housing, further forcing the working fluid to flow against the diaphragm. Thus, the interface between the diaphragm, the cage, the seal, and the housing can facilitate operation of the pinch valve subassembly to transition to the closed configuration. The cage can be sized to enable the pinch valve subassembly to be readily insertable into the cavity and fluidically coupled to a conduit of the conduit system. For example, in many embodiments, the pinch valve subassembly can be secured within the conduit system and fluidically coupled to the conduit by inserting the pinch valve subassembly in the cavity of the conduit system without the use of additional locating components (e.g. without the use of pins or fasteners). As such, implementation of the pinch valve subassembly can be simplified to improve ease of manufacture and/or of production of the conduit system.

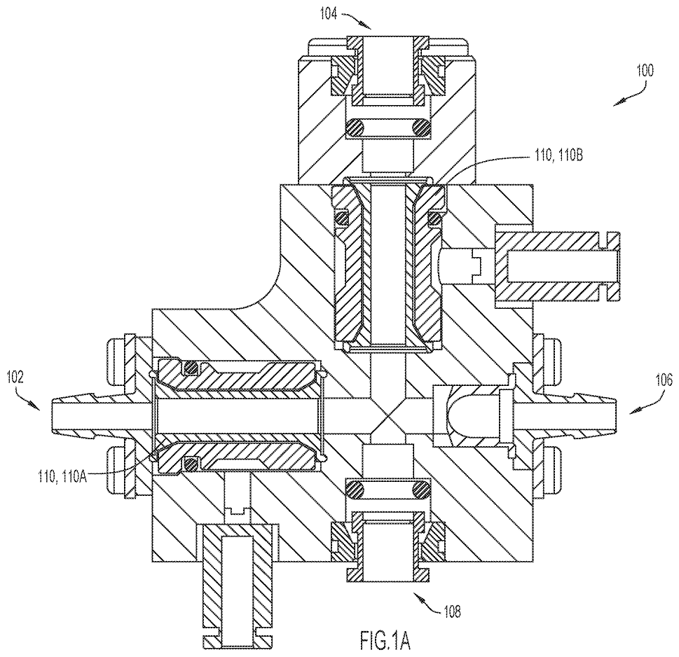

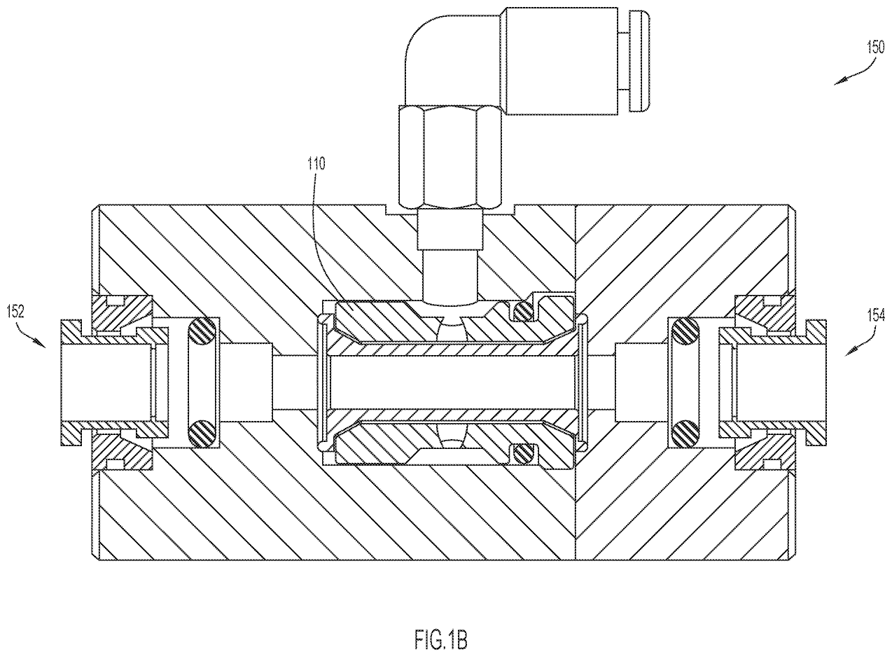

FIG. 1A is a cross-sectional view of an example conduit system 100 in which aspects of the techniques presented herein can be implemented. The illustrated conduit system 100 includes a manifold configuration that can include multiple inlets and/or multiple outlets. By way of example, the conduit system 100 can include a first port 102, a second port 104, a third port 106, and a fourth port 108. Each of the ports 102, 104, 106, 108 enables flow of a process fluid (e.g., a liquid, a gas, a vapor-gas mixture, a slurry, a mixture of material) into and/or out of the conduit system 100. In some embodiments, the conduit system 100 can be configured to discharge process fluid to different locations via multiple ones of the ports 102, 104, 106, 108. Additionally or alternatively, the conduit system 100 can be configured to intake process fluid from different locations via multiple ones of the ports 102, 104, 106, 108. Indeed, the illustrated conduit system 100 can distribute and/or combine different process fluids. In an example embodiment, the conduit system 100 can receive a process fluid flow via the second port 104 and distribute the process fluid between the first port 102, the third port 106, and the fourth port 108 for discharge from the conduit system 100. In another example embodiment, the conduit system 100 can receive respective process fluid flows via the second port 104 and the fourth port 108, combine the respective process fluid flows into a combined process fluid flow, and discharge the combined process fluid flow from the conduit system 100 via the first port 102.

The conduit system 100 includes a first pinch valve subassembly 110A fluidically coupled to the first port 102 and configured to control process fluid flow through the first port 102 (e.g., into the conduit system 100, out of the conduit system 100). The conduit system 100 also includes a second pinch valve subassembly 110B fluidically coupled to the second port 104 and configured to control process fluid flow through the second port 104 (e.g., into the conduit system 100, out of the conduit system 100). For example, as discussed herein, each pinch valve subassembly 110 can define an opening through which the process fluid can flow. The pinch valve subassembly 110 can flex or deform to adjust a size of the opening, thereby changing a flow characteristic (e.g., a flow rate, a flow speed, a flow amount) of the process fluid through the pinch valve subassembly 110 and a corresponding port 102, 104. As such, the pinch valve subassemblies 110 can be used to adjust process fluid flow through the conduit system 100, such as a manner in which the conduit system 100 distributes and/or combines different process fluid flows.

In the illustrated embodiment, the pinch valve subassemblies 110 are positioned to arrange respective flows of process fluid through the first pinch valve subassembly 110A and through the second pinch valve subassembly 110B in a crosswise (e.g., perpendicular) orientation relative to one another. However, in an alternative embodiment, the pinch valve subassemblies 110 can be positioned to arrange the respective flows of process fluid in line or in parallel with one another.

FIG. 1B is a cross-sectional view of an example conduit system 150 in which aspects of the techniques presented herein can be implemented. The conduit system 150 includes an inline configuration that includes a single inlet and a single outlet. Thus, the illustrated conduit system 150 can receive and discharge a single process fluid flow. For example, the conduit system 150 includes a first port 152 and a second port 154 that can each enable process fluid flow into and/or out of the conduit system 150. The conduit system 150 also includes a pinch valve subassembly 110 fluidically coupled to the first port 152 and to the second port 154. The pinch valve subassembly 110 can control process fluid flow between the ports 152, 154 to control process fluid flow through the conduit system 150. For example, an opening defined by the pinch valve subassembly 110 can be adjusted to increase or decrease flow of process fluid through the conduit system 150 via the ports 152, 154.

The ports 152, 154 of the illustrated conduit system 150 are collinear (e.g., axially aligned) with one another. Thus, process fluid can flow in a substantially straight path between the ports 152, 154. In an alternative embodiment, the ports 152, 154 can be offset from one another. For instance, the ports 152, 154 can be oriented such that process fluid flows at least partially in a curved, an arcuate, a stepped, a wave-like, or other non-linear path between the ports 152, 154.

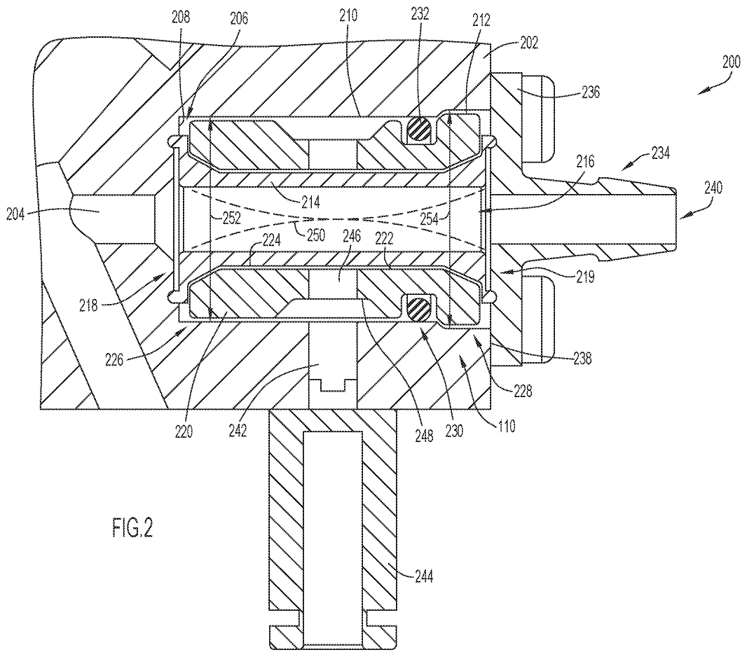

FIG. 2 is a cross-sectional view of the pinch valve subassembly 110 employed in a conduit system 200 (e.g., the conduit system 100, the conduit system 150). The conduit system 200 includes a housing 202 (e.g., an outer housing, an enclosure) that contains a conduit 204. The housing 202 defines a cavity or recess 206 (e.g., a blind hole extending to a specific depth into the housing 202), and the conduit 204 is fluidically coupled to the cavity 206. Thus, the conduit 204 can receive process fluid from and/or discharge process fluid to the cavity 206.

The pinch valve subassembly 110 can be insertable into the cavity 206 and can fluidically couple to the conduit 204 in an installed configuration of the pinch valve subassembly 110 in the cavity 206. By way of example, the housing 202 can include a back surface 208, first interior housing walls 210 extending from the back surface 208, and second interior housing walls 212 extending from the first interior housing walls 210. The back surface 208, the first interior housing walls 210, and the second interior housing walls 212 are exposed to and cooperatively define outer boundaries of the cavity 206. The pinch valve subassembly 110 can include a diaphragm 214, which can have a body with a tubular profile that defines an opening 216 extending from a first diaphragm end 218 to a second diaphragm end 219 of the body. In the installed configuration, the first diaphragm end 218 can abut against the back surface 208, and the opening 216 of the diaphragm 214 can overlap with (e.g., concentrically align with) the conduit 204. Thus, process fluid can flow between the conduit 204 and the diaphragm 214.

The pinch valve subassembly 110 also includes a cage 220 (e.g., a sleeve) in which the diaphragm 214 can be disposed. As an example, the cage 220 can include an interior cage surface 222 that is configured to face and accommodate a profile of an exterior diaphragm surface 224 of the diaphragm 214. That is, the interior cage surface 222 can be disposed around and capture the exterior diaphragm surface 224 in a sealing engagement to secure the diaphragm 214 within the cage 220. In some embodiments, the diaphragm 214 can be manually insertable into and manually removable from the cage 220. For instance, the diaphragm 214 can be composed of a sufficiently pliable material (e.g., an elastomer), and the diaphragm 214 can partially deform to enable insertion of the diaphragm 214 through and within the cage 220. An example material of the diaphragm 214 is silicone (e.g., medical grade silicone) to provide desirable pliability, as well as degradation resistance (e.g. chemical and/or mechanical degradation resistance) and compatibility with various process fluid compositions (e.g., hydrogen peroxide). The diaphragm 214 can also partially deform to enable removal of the diaphragm 214 from within the cage 220.

The cage 220 can also help secure the pinch valve subassembly 110 within the cavity 206. For instance, the cage 220 can include a first cage end 226, a second cage end 228, and a recess 230 disposed between the first cage end 226 and the second cage end 228. The recess 230 can extend (e.g., circumferentially extend) about a perimeter of the cage 220, and the recess 230 can receive a seal 232 (e.g., an O-ring). In additional or alternative embodiments, the cage 220 does not include the recess 230, and the seal 232 can directly engage with or secure to the second cage end 228. In the installed configuration of the pinch valve subassembly 110, the seal 232 can abut and be compressed against the first interior housing walls 210 of the housing 202 (e.g., via an interference fit).

As an example, the seal 232 can be composed of a material (e.g., rubber, such as ethylene propylene diene monomer, polytetrafluoroethylene, silicone, such as medical grade silicone) that can impart a threshold amount of frictional force against the first interior housing walls 210. Thus, abutment between the seal 232 and the first interior housing walls 210 can block relative movement between the seal 232 and the housing 202. As such, the seal 232 can block relative movement between the cage 220, as well as the diaphragm 214 secured within the cage 220, and the housing 202 to secure the pinch valve subassembly 110 within the cavity 206. Abutment between the seal 232 and the cage 220 can also provide desirable positioning of the pinch valve subassembly 110 within the cavity 206. For example, the seal 232 can cause the pinch valve subassembly 110 to be centered (e.g., concentrically aligned) within the cavity 206. Furthermore, the second cage end 228 can abut against the second interior housing walls 212 in the installed configuration of the pinch valve subassembly 110 within the cavity 206 (e.g., via an interference fit). Abutment between the second cage end 228 and the second interior housing walls 212 can further block relative movement between the pinch valve subassembly 110 and the housing 202.

The conduit system 200 can also include a cap or connector 234 configured to couple to the housing 202 and extend over the cavity 206. For example, the cap 234 can include flanges 236 configured to engage exterior housing walls 238, and the flanges 236 can extend at least partially over the cavity 206. The cap 234 can also define an opening 240, and the opening 240 can be fluidically coupled to the opening 216 of the pinch valve subassembly 110 in an installed configuration of the cap 234 to the housing 202. Thus, process fluid can flow between the pinch valve subassembly 110 and the cap 234 via the openings 216, 240.

In some embodiments, the cap 234 can facilitate desirable flow of process fluid between the conduit 204, the pinch valve subassembly 110, and the cap 234. For example, in the installed configuration of the cap 234 to the housing 202, the cap 234 can compress against the second diaphragm end 219 and compress the first diaphragm end 218 and the back surface 208 of the housing 202 against one another. In this manner, the cap 234 can provide a sealed engagement between the diaphragm 214 and the cap 234, as well as between the diaphragm 214 and the back surface 208. As such, undesirable process fluid flow between the back surface 208 and the first diaphragm end 218 and/or between the second diaphragm end 219 and the cap 234 can be blocked, thereby forcing process fluid flow through the conduit 204, the pinch valve subassembly 110, and the cap 234.

As discussed herein, the diaphragm 214 can flex or deform to adjust a size of the opening 216. For example, the sufficiently pliable material of the diaphragm 214 can enable some flexure of the diaphragm 214. In some embodiments, the conduit system 200 can be configured to cause flexure of the diaphragm 214 via a working fluid (e.g., compressed air). For example, the housing 202 can define a working fluid line 242, and the conduit system 200 can include a working fluid source 244 fluidically coupled to the working fluid line 242. The working fluid source 244 can be configured to direct working fluid toward the pinch valve subassembly 110 via the working fluid line 242. The cage 220 can include an opening 246 (e.g., a through-hole) that extends through an outer surface 248 of the cage 220 to the interior cage surface 222. The opening 246 can expose a portion (e.g., the exterior diaphragm surface 224) of the diaphragm 214 disposed within the cage 220, thereby fluidically coupling (e.g., pneumatically coupling) the portion of the diaphragm 214 and the outer surface 248 to one another. The opening 246 can also be fluidically coupled to the working fluid line 242. As such, the working fluid source 244 can output working fluid through the working fluid line 242, into the opening 246, and against the diaphragm 214. The working fluid output against the diaphragm 214 can provide a sufficient force to cause the diaphragm 214 to flex and adjust the opening 216. By way of example, the working fluid source 244 can output the working fluid to compress the diaphragm 214 from an open configuration toward a closed configuration 250 (shown in phantom lines), which can reduce a flow rate of process fluid through the opening 216.

The material of the diaphragm 214 can also be sufficiently resilient such that absent a force imparted onto the diaphragm 214, the diaphragm 214 can adjust toward a base shape or profile. For example, absent the working fluid output by the working fluid source 244, the diaphragm 214 can expand and transition out of the closed configuration 250 to increase the flow rate of process fluid through the opening 216. As such, the working fluid source 244 can be operated (e.g., manually via a user, automatically via a controller) to adjust the flow of process fluid through the pinch valve subassembly 110.

In certain embodiments, the first cage end 226 and the second cage end 228 can cooperatively provide a poka-yoke feature that enables desirable positioning and/or orientation of the pinch valve subassembly 110 within the cavity 206. For example, it can be desirable to position the pinch valve subassembly 110 within the cavity 206 such that the seal 232, which is more adjacent to the second diaphragm end 219 than to the first diaphragm end 218, is positioned more adjacent to the cap 234 than to the conduit 204. Accordingly, it can be desirable to insert the pinch valve subassembly 110 into the cavity 206 such that the first cage end 226 is the leading end that is initially inserted into the cavity 206 toward the back surface 208 and the second cage end 228 is the trailing end that is subsequently inserted into the cavity 206.

To this end, the second cage end 228 can extend radially beyond the first cage end 226. Additionally, the first interior housing walls 210 can be offset (e.g., non-collinear) from the second interior housing walls 212 to provide a first distance 252 spanning between the first interior housing walls 210 that is less than a second distance 254 spanning between the second interior housing walls 212. The second distance 254 between the second interior housing walls 212 can accommodate the dimensions (e.g., a width) of the first cage end 226 and of the second cage end 228. Thus, each of the first cage end 226 and the second cage end 228 can extend between the second interior housing walls 212. However, the first distance 252 between the first interior housing walls 210 can accommodate the dimensions (e.g., a width) of the first cage end 226 but not of the second cage end 228. As such, the first interior housing walls 210 can block positioning of the second cage end 228 therebetween and therefore block abutment of the second cage end 228 against the back surface 208. In this manner, the offset between the first interior housing walls 210 and the second interior housing walls 212 can force the first cage end 226 to be inserted into the cavity 206 before the second cage end 228 is inserted into the cavity 206 to enable the first diaphragm end 218 to abut against the back surface 208 and fully insert the pinch valve subassembly 110 into the cavity 206.

It should be noted that the cage 220 can be composed of a sufficiently rigid material (e.g., metal, a copolymer, hard plastic, such as acetal) that avoids substantial deformation and provides desirable machining characteristics for forming the recess 230, the opening 246, and so forth. For instance, the material of the cage 220 can block deformation of the second cage end 228 that would otherwise enable the second cage end 228 to be inserted between the first interior housing walls 210. Thus, the material of the cage 220 can block undesirable orientation of the cage 220 within the cavity 206. Additionally, the material of the cage 220 can block deformation of the cage 220 by working fluid flow. That is, the profile of the cage 220 can generally be maintained while working fluid flows through the working fluid line 242. The maintained profile of the cage 220 can enable the cage 220 to remain in contact with the diaphragm 214 (e.g., the first diaphragm end 218, the second diaphragm end 219) while the working fluid causes flexure of the diaphragm 214.

In some embodiments, the conduit system 200 can have multiple cavities 206, and the pinch valve subassembly 110 can be readily insertable into any of the cavities 206. Thus, implementation of the pinch valve subassembly 110 can be further simplified. For example, pinch valve subassemblies 110 of a common embodiment (e.g., having a common embodiment of the diaphragm 214, having a common embodiment of the cage 220) can be provided for insertion into each of the cavities 206. Thus, manufacture, purchase, and/or installation of different embodiments of pinch valve subassemblies 110 (e.g., each dedicated for insertion into a particular one of the cavities 206) can be avoided. Usage of a single embodiment of the pinch valve subassembly 110 can also simplify other operations performed with respect to the conduit system 200, such as maintenance, replacement, and/or inspection of the pinch valve subassemblies 110.

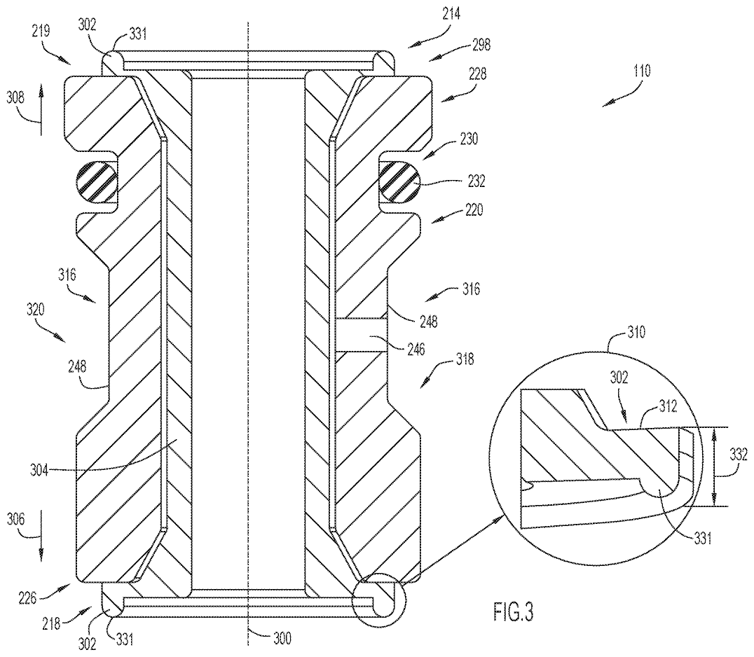

FIG. 3 is a cross-sectional view of the pinch valve subassembly 110 in an assembled configuration in which the diaphragm 214 is disposed within the cage 220. As an example, the cage 220 includes a hole 298 extending from the first cage end 226 to the second cage end 228, and the hole 298 is configured to receive the diaphragm 214 (e.g., by inserting one of the diaphragm ends 218, 219 into the hole 298 at one of the cage ends 226, 228 and then pulling the diaphragm 214 through the hole 298 to the other of the cage ends 226, 228). As a result, the diaphragm 214 extends from the first cage end 226 to the second cage end 228 and is in a sealing engagement with the cage 220. Each of the diaphragm 214 and the cage 220 can define an elongate structure extending along a longitudinal axis 300. For example, each of the diaphragm 214 and the cage 220 can have a generally cylindrical and tubular profile (e.g., having a circular cross-sectional geometry). However, it should be noted that either of the diaphragm 214 and the cage 220 can alternatively have any other suitable corresponding shape, such as a prismatic profile.

As discussed herein, the cage 220 can secure the diaphragm 214 therein. For example, each of the first diaphragm end 218 and the second diaphragm end 219 can include flanges 302 that extend radially outward relative to a main body 304 of the diaphragm 214. These flanges 302 can include raised sealing rings/lips 331 (e.g., circumferential extensions extending from the flanges) extending along the longitudinal axis. In certain examples, the cage ends 226, 228 can engage the flanges 302 to secure the diaphragm 214 within the cage 220. That is, the first cage end 226 can abut the flanges 302 of the first diaphragm end 218, and the second cage end 228 can abut the flanges 302 of the second diaphragm end 219. In some embodiments, the cage ends 226, 228 can impart a force onto the respective flanges 302 to place the diaphragm 214 in tension along the longitudinal axis 300. In this example, the raised sealing rings 331 function to form a seal between with the cage ends 226, 228.

For instance, the first cage end 226 can impart a force onto the flanges 302 of the first diaphragm end 218 in a first direction 306, and the second cage end 228 can impart a force onto the flanges 302 of the second diaphragm end 219 in a second direction 308, opposite the first direction 306. In other words, the respective cage ends 226, 228 can impart forces in the directions 306, 308 away from one another to stretch the diaphragm 214 away from its base shape. However, the resilient property of the diaphragm 214 can urge the diaphragm 214 to compress toward its base shape. In other words, the diaphragm ends 218, 219 can be urged toward one another. The urging of the diaphragm ends 218, 219 toward one another can cause the diaphragm ends 218, 219 to compress onto the cage ends 226, 228, thereby maintaining contact with the cage ends 226, 228. That is, the raised sealing rings 331 at the first diaphragm end 218 can compress against the first cage end 226, and the raised sealing rings 331 of the second diaphragm end 219 can compress against the second cage end 228. Such contact between the raised sealing rings 331 and the cage ends 226, 228 can provide a seal between the diaphragm 214 and the cage 220, as further described herein.

Detailed view 310 provides a close-up visualization of the flanges 302, each of which includes a base portion 312 and the raised sealing ring 331 (raised portion) extending longitudinally from the base portion 312. As noted, the raised sealing rings 331 can facilitate maintaining contact between the flanges 302 and the cage 220 extending between the diaphragm ends 218, 219. In this way, the raised sealing rings 331 provide the seal between the diaphragm 214 and the cage 220. The raised sealing rings 331 can also help provide the seal between the diaphragm 214 and a housing/cap for securing the pinch valve subassembly 110 within a cavity of the housing. For instance, the elevated profile of the raised sealing rings 331 enables the raised sealing rings 331 to extend sufficiently away from the cage ends 226, 228, respectively, while in abutment with the cage ends 226, 228. Thus, the raised sealing rings 331 may be arranged to provide greater engagement against the housing (e.g., a back surface of the housing) and/or the cap positioned adjacent to the cage ends 226, 228 (e.g., while the pinch valve subassembly 110 is positioned in the cavity of the housing). In certain embodiments, the raised sealing rings 331 can circumferentially extend about the main body 304, thereby forming a ring configuration to provide a seal along a perimeter of the diaphragm 214.

The flanges 302 also have a sufficient thickness 332 to maintain a desirable shape of the diaphragm 214. By way of example, the thickness 332 is sized such that the flanges 302 can absorb a compressive force (e.g., imparted by the cap 234) and avoid transfer of the compressive force to the main body 304 to prevent or at least discourage the compressive force from distorting the diaphragm 214 (e.g., by bending the main body 304) in a manner that would reduce a seal between the diaphragm 214 and the cage 220 and/or between the diaphragm 214 and the cap 234. As such, the sizing of the flanges 302 further helps maintain desirable positioning and functionality of the pinch valve subassembly 110.

As discussed herein, the cage 220 can include an opening 246 that enables working fluid to abut against the diaphragm 214 to transition the pinch valve subassembly 110 to the closed configuration 250. For instance, the opening 246 is formed through the outer surface 248 that extends between the first cage end 226 and the second cage end 228, and the opening 246 extends transverse to the longitudinal axis 300 to the hole 298, thereby exposing the main body 304 of the diaphragm 214 positioned within the cage 220. The cage 220 can also include a cavity 316 (e.g., a pneumatic cavity) to facilitate directing of working fluid into the opening 246. For instance, the cavity 316 can include an indentation having a V-shape, a U-shape, a beveled shape, a parabolic shape, a tapered shape, and so forth, that can guide flow of working fluid into the opening 246. Moreover, the cavity 316 can extend circumferentially about the cage 220, and the opening 246 can be disposed in a portion of the cavity 316 and extend inwardly from the outer surface 248 of the cage 220 within the cavity 316 and toward the main body 304 of the diaphragm 214. In this manner, working fluid directed into the cavity 316 (e.g., via the working fluid source 244 by way of the working fluid line 242) can flow along the outer surface 248 of the cage 220 and into the opening 246 to flow onto the main body 304. As an example, the cavity 316 can circumferentially extend from a first cage side 318 (e.g., a first lateral side) of the cage 220 to a second cage side 320 (e.g., a second lateral side) of the cage 220, but the opening 246 can be formed at the first cage side 318 and not the second cage side 320. However, working fluid directed into the cavity 316 at the second cage side 320 can flow along the outer surface 248, circumferentially around the cage 220 from the second cage side 320 to the first cage side 318 (e.g., to pressurize a chamber formed between the cavity 316 and the first interior housing walls 210 of the housing 202), and into the opening 246 at the second cage side 320.

As such, so long as the working fluid line 242 is fluidically coupled to the cavity 316, the opening 246 can be able to receive working fluid via the working fluid line 242, even though the working fluid line 242 may not be directly aligned with (e.g., concentric to) the working fluid line 242. In other words, the opening 246 can receive working fluid directed into any part of the cavity 316. Therefore, the pinch valve subassembly 110 can be more easily installed (e.g., manually installed by a user) into the housing 202 to enable desirable operation of the pinch valve subassembly 110, such as without having to position the pinch valve subassembly 110 in a specific orientation to align the opening 246 with the working fluid line 242. For example, the pinch valve subassembly 110 can be installed in multiple different orientations that are rotationally offset from one another about the longitudinal axis 300, but still enable the opening 246 to receive working fluid to transition the pinch valve subassembly 110 toward the closed configuration 250.

It should also be noted that the tension of the diaphragm 214 imparted by the cage 220 can maintain desirable structure of the diaphragm 214, such as while working fluid is directed to transition the pinch valve subassembly 110 to the closed configuration 250. For example, because of the pliable property of the diaphragm 214, certain forces imparted onto the diaphragm 214 that is not under a tensile force can cause sudden, undesirable changes in shape of the diaphragm 214 (e.g., buckling), such as undesirable movement of either of the diaphragm ends 218, 219. Such movement can otherwise cause disengagement between the diaphragm ends 218, 219 and a corresponding cage end 226, 228, thereby reducing the coupling between the diaphragm 214 and the cage 220 and/or reducing the seal provided between the diaphragm 214 and the cage 220. Tension of the diaphragm 214 (e.g., via the cage 220) can mitigate the undesirable changes in shape of the diaphragm 214. Thus, tension of the diaphragm 214 can improve the interface between the diaphragm 214 and the cage 220 to provide and maintain desirable coupling and/or sealing between the diaphragm 214 and the cage 220, even when external forces are imparted onto the diaphragm 214 (e.g., by the working fluid).

Moreover, tension of the diaphragm 214 can distribute forces imparted onto the pinch valve subassembly 110 along the longitudinal axis 300. The stretched configuration of the diaphragm 214 under tension can cause the force to distribute circumferentially about the diaphragm 214 (e.g., around the second diaphragm end 219). As such, the force can be more evenly or uniformly imparted onto the diaphragm 214, further blocking undesirable changes in shape of the diaphragm 214. As an example, bending of the diaphragm 214 (e.g., of the main body 304), which can otherwise be caused by an uneven distribution of force to result in a relatively higher amount of force imparted along the longitudinal axis 300 on a particular side of the diaphragm 214, can be avoided via the more even distribution of forces.

In the illustrated embodiment, the recess 230, as well as the seal 232 disposed within the recess 230, is disposed between the second cage end 228 and the opening 246 along the longitudinal axis 300. Additionally, the seal 232 disposed within the recess 230 can extend radially beyond the outer surface 248 of the cage 220. In this manner, the seal 232 can maintain contact with the first interior housing walls 210 that surrounds the outer surface 248 of the cage 220 in the installed configuration of the pinch valve subassembly 110. For example, the seal 232 can be positioned between the first interior housing walls 210 and adjacent to the second interior housing walls 212 in the installed configuration.

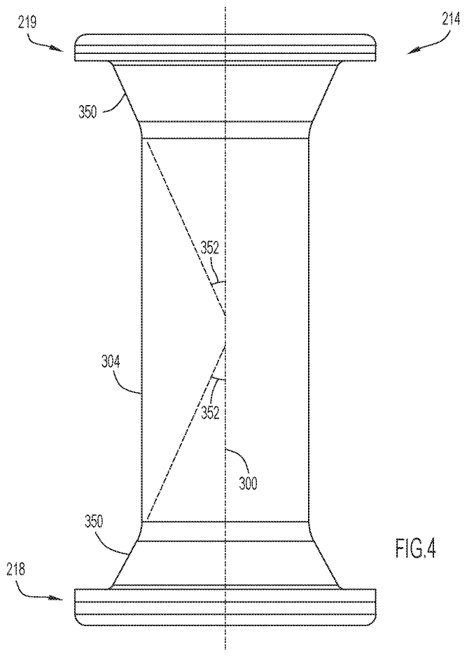

FIG. 4 is a side view of the diaphragm 214. The illustrated diaphragm 214 includes the main body 304, which extends generally along the longitudinal axis 300. Additionally, the diaphragm 214 includes the diaphragm ends 218, 219 that extend radially beyond the main body 304. Moreover, the diaphragm 214 can include tapered portions 350 extending between the main body 304 and the diaphragm ends 218, 219 to provide transition areas. The transition areas (embodied by tapered portions 350 and versions thereof) can extend radially outward from the main body 304 at an oblique angle 352 relative to the longitudinal axis 300. Thus, the transition areas can provide a smooth transition from the relatively thinner main body 304 to the relatively wider diaphragm ends 218, 219. Such a transition can further enable the diaphragm 214 to maintain a desirable shape. For example, the tapered portions 350 can help absorb a portion of a strain imparted onto the diaphragm 214 (e.g., by the working fluid directed against the main body 304) to reduce an amount of the strain imparted onto another part of the diaphragm (e.g., onto the diaphragm ends 218, 219). The reduction of the amount of strain imparted onto the other part of the diaphragm ends 218, 219 can resist undesirable changes in the shape of the diaphragm 214. For instance, the tapered portions 350 can help maintain desirable sealing between the diaphragm 214 and the cage 220 while a force is imparted onto the diaphragm 214.

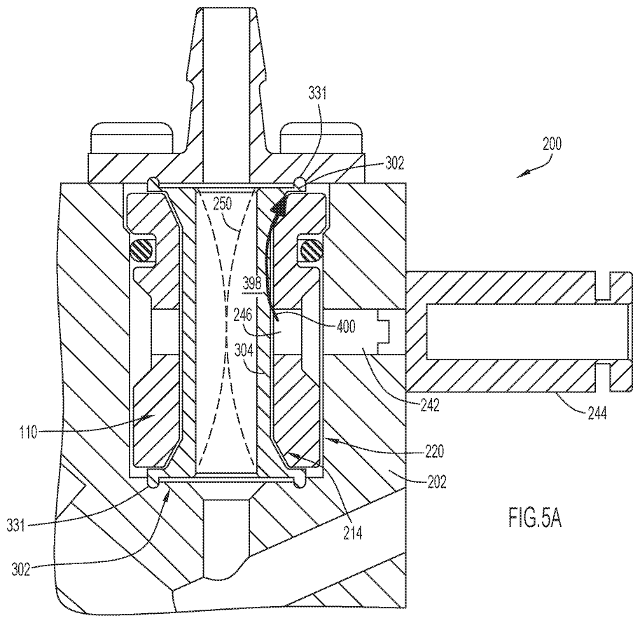

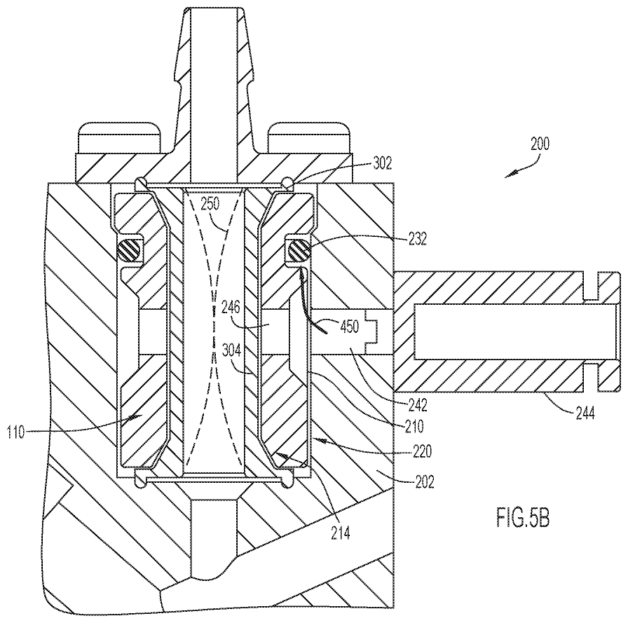

FIG. 5A is a cross-sectional view of the conduit system 200 having the pinch valve subassembly 110 installed therein. As discussed herein, the flanges 302 (raised sealing rings 331) of the diaphragm 214 can maintain contact with the cage 220 to provide a seal between the diaphragm 214 and the cage 220. The seal provided between the diaphragm 214 and the cage 220 can block undesirable flow of working fluid out of the pinch valve subassembly 110. For example, during operation of the working fluid source 244 to output working fluid, the working fluid can flow through the working fluid line 242, into the opening 246 of the cage 220, and against the main body 304 to compress the main body 304 and transition the pinch valve subassembly 110 to the closed configuration 250. Compression of the main body 304 can move a portion of the main body 304 inwardly away from the cage 220, thereby forming a space 398 between the main body 304 and the cage 220. Thus, the working fluid can flow along a first working fluid flow path 400 into the space 398 formed between the main body 304 and the cage 220. However, the flanges 302 can remain in a sealed engagement with the cage 220 in the closed configuration 250 of the pinch valve subassembly 110, and the sealed engagement between the flanges 302 and the cage 220 can block flow of working fluid between the flanges 302 and the cage 220. As such, flow of working fluid from the space 398 out of the pinch valve subassembly 110 via the interface between the flanges 302 and the cage 220 can be blocked. Therefore, the sealed engagement between the flanges 302 and the cage 220 can force the working fluid to impinge against the main body 304 to drive compression of the main body 304 and establish the closed configuration 250 of the pinch valve subassembly 110.

FIG. 5B is a cross-sectional view of the conduit system 200 having the pinch valve subassembly 110 installed therein. In the installed configuration of the pinch valve subassembly 110, a portion of the cage 220 can be offset from the first interior housing walls 210 of the housing 202. Thus, during operation of the working fluid source 244 to output working fluid, a portion of the working fluid can flow along a second working fluid flow path 450 between the cage 220 and the first interior housing walls 210. However, the seal 232 of the pinch valve subassembly 110 can remain in a sealed engagement with the first interior housing walls 210 in the closed configuration 250 of the pinch valve subassembly 110. Thus, the seal 232 can block undesirable flow of working fluid between the cage 220 and the housing 202 (e.g., and out of the cavity 206), further forcing the working fluid to flow against the main body 304.

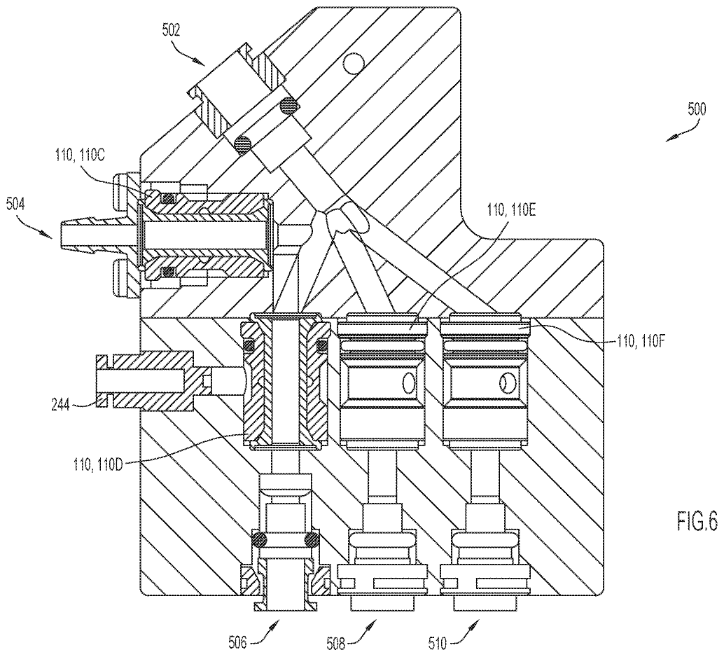

FIG. 6 is a cross-sectional view of an example conduit system 500 in which aspects of the techniques presented herein can be implemented. The illustrated conduit system 500 includes multiple pinch valve subassemblies 110 positioned in a parallel configuration with respect to one another. For example, the conduit system 500 can include a third pinch valve subassembly 110C, a fourth pinch valve subassembly 110D, a fifth pinch valve subassembly 110E, and a sixth pinch valve subassembly 110F. Each of the pinch valve subassemblies 110 can be fluidically coupled to a first port 502. Thus, process fluid can flow between the first port 502 and each of the pinch valve subassemblies 110C, 110D, 110E, 110F. Additionally, the pinch valve subassemblies 110C, 110D, 110E, 110F can be fluidically coupled to additional, respective ports. For instance, the third pinch valve subassembly 110C can be fluidically coupled to a second port 504, the fourth pinch valve subassembly 110D can be fluidically coupled to a third port 506, the fifth pinch valve subassembly 110E can be fluidically coupled to a fourth port 508, and the sixth pinch valve subassembly 110F can be fluidically coupled to a fifth port 510. The pinch valve subassemblies 110 can control respective process fluid flows through the ports 504, 506, 508, 510. By way of example, a separate working fluid source 244 can control the configuration of the pinch valve subassemblies 110 to adjust process fluid flow through the pinch valve subassemblies 110 and a corresponding one of the ports 504, 506, 508, 510. In this manner, the pinch valve subassemblies 110 can control the flow of process fluid between the first port 502 and each of the other ports 504, 506, 508, 510.

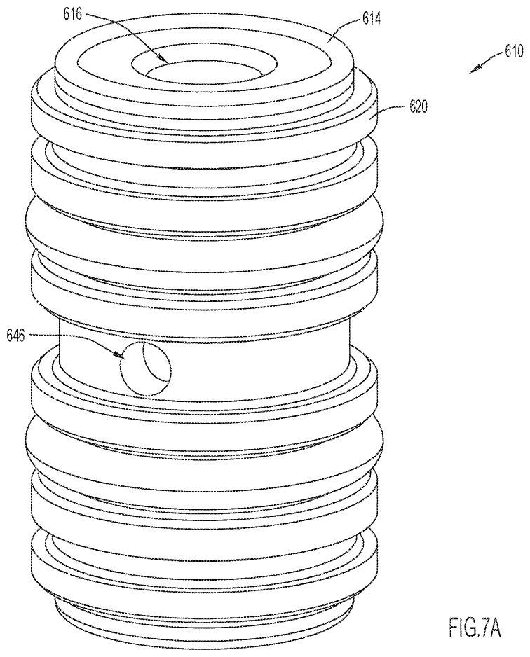

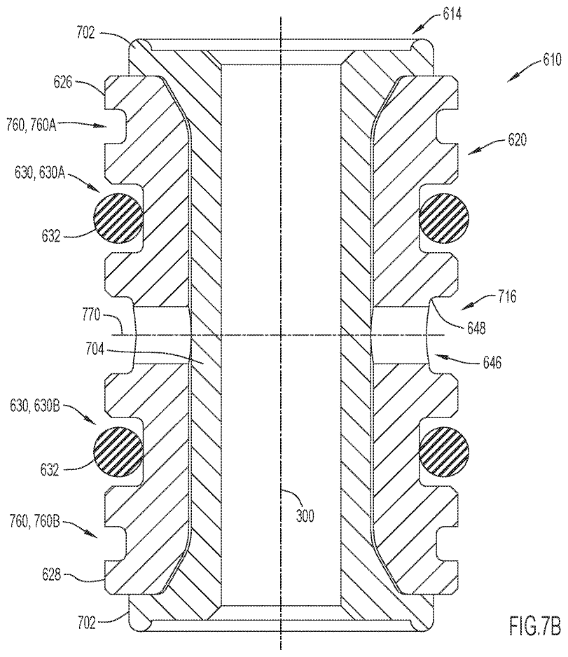

It should be noted that a differently shaped pinch valve subassembly can be utilized in certain implementations. For example, an alternative pinch valve subassembly has a different diaphragm shape/arrangement and/or a different cage shape/arrangement. FIGS. 7A, 7B, 8-10, 11A, and 11B illustrate various pinch valve subassembly embodiment and/or conduit systems incorporating a different pinch valve subassembly arrangement. However, it should be noted that each of the pinch valve subassemblies discussed herein can be used in the same conduit system, such as positioned within similar cavities. Indeed, in some embodiments, the different pinch valve subassembly embodiments can be interchangeably utilized such that a single conduit system can incorporate different pinch valve subassembly embodiments and/or one pinch valve subassembly embodiment can replace another pinch valve subassembly embodiment for the same conduit system.

FIG. 7A is a perspective view of another pinch valve subassembly 610 in an assembled configuration in which a diaphragm 614 is disposed within a cage 620. The illustrated diaphragm 614 may be similar to the diaphragm 214, whereas the illustrated cage 620 includes different features from the cage 220, as further described herein. The diaphragm 614 includes an opening 616 configured to direct process fluid through the diaphragm 614, and the cage 620 includes an opening 646 (e.g., at least one opening) that exposes the diaphragm 614 and is configured to direct working fluid to the diaphragm 614 to close the pinch valve subassembly 610.

FIG. 7B is a cross-sectional view of the pinch valve subassembly 610 having the diaphragm 614 secured within the cage 620, such as via flanges 702 extending radially outward relative to a main body 704 and abutting and sealing against respective cage ends 626, 628 of the diaphragm 614 (e.g., to place the diaphragm 614 in tension along the longitudinal axis 300). The opening 646 fluidically couples the main body 704 to an outer surface 648 of the cage 620 to enable working fluid to abut the diaphragm 614 to deform the main body 704 and transition the pinch valve subassembly 610 to a closed configuration. The cage 620 can also include a cavity 716 with an indentation having a shape (e.g., a V-shape, a U-shape, a beveled shape, a parabolic shape, a tapered shape) that can guide flow of working fluid into the opening 646. The cavity 716 can extend circumferentially about the cage 620, and the opening 646 can be disposed in a portion of the cavity 716 and extend inwardly from the outer surface 648 of the cage 620 toward the main body 704 of the diaphragm 614 such that working fluid directed into the cavity 716 can flow along the outer surface 648 and into the opening 646 to flow onto the main body 704. Therefore, the pinch valve subassembly 610 can be more easily installed, such as in various rotational orientations, to enable desirable operation (e.g., flow of working fluid onto the main body 704) so long as the cavity 716 can receive working fluid.

The cage 620 includes a first recess 630A disposed between the opening 646 and a first cage end 626 of the diaphragm 614 along the longitudinal axis 300, as well as a second recess 630B disposed between the opening 646 and a second cage end 628 of the diaphragm 614 along the longitudinal axis 300. Each of the recesses 630 are configured to receive a respective seal 632 (e.g., a respective O-ring) to secure the pinch valve subassembly 610 in a housing. The cage 620 also includes a first groove or cutout 760A (e.g., a first circumferential groove) disposed between the first recess 630A and the first cage end 626 along the longitudinal axis 300, as well as a second groove or cutout 760B (e.g., a second circumferential groove) disposed between the second recess 630B and the second cage end 628 along the longitudinal axis 300. The grooves 760 can help with installation and/or removal of the pinch valve subassembly 610 with respect to a housing, as further discussed herein.

In the illustrated embodiment, the opening 646 of the cage 620 is aligned with a center axis 770 extending perpendicular to the longitudinal axis 300 at a center of the diaphragm 614 and of the cage 620 along the longitudinal axis 300. The recesses 630 are approximately symmetrical about the center axis 770, and the grooves 760 are approximately symmetrical about the center axis 770. Therefore, the opening 646 is positioned equidistant to each seal 632, as well as to each groove 670. Such a configuration of the pinch valve subassembly 610 can help facilitate an ease of installation of the pinch valve subassembly 610 and desirable positioning of the pinch valve subassembly 610 upon installation. For example, either cage end 626, 628 of the illustrated pinch valve subassembly 610 can be the leading end that is initially inserted into a cavity (e.g., toward a back surface) of a conduit system, and either cage end 626, 628 can be the trailing end that is subsequently inserted into the cavity. Thus, the pinch valve subassembly 610 can be installed in multiple orientations. For this reason, a user does not need to orient the pinch valve subassembly 610 in a specific manner (e.g., to have a particular one of the cage end 626, 628 be the leading end) to enable installation of the pinch valve subassembly 610. However, in additional or alternative embodiments, one of the cage ends 626, 628 extends radially beyond the other of the cage ends 626, 628. For instance, the cage 620 has a tapered or frustoconical configuration and is configured to be positioned within a cavity having a corresponding shape. Such a configuration of the cage 620 and of the cavity provides a poka-yoke feature to help insert the pinch valve subassembly 610 into the cavity, such as by facilitating the smaller of the cage ends 626, 628 to be the leading end that can be initially inserted into the cavity without contacting the walls (e.g., tapered walls) defining the cavity. Moreover, by utilizing separate seals 632 on opposite sides of the center axis 770, movement of the pinch valve subassembly 610 can be better restricted. As an example, the seal 632 disposed in the first recess 630A and more adjacent to the first cage end 626 can block movement of the first cage end 626, and the seal 632 disposed in the second recess 630B more adjacent to the second cage end 628 can block movement of the second cage end 628. Thus, movement of both cage ends 626, 628 is better restricted with the separate seals 632. Further still, symmetry of the pinch valve subassembly 610 about the center axis 770 can help distribute forces more evenly, such as by avoiding concentration of forces at a certain part (e.g., one of the ends) of the diaphragm 614. As a result, a desirable shape of the diaphragm 614 can be maintained, such as to seal against the cage 620 and/or against a conduit system housing.

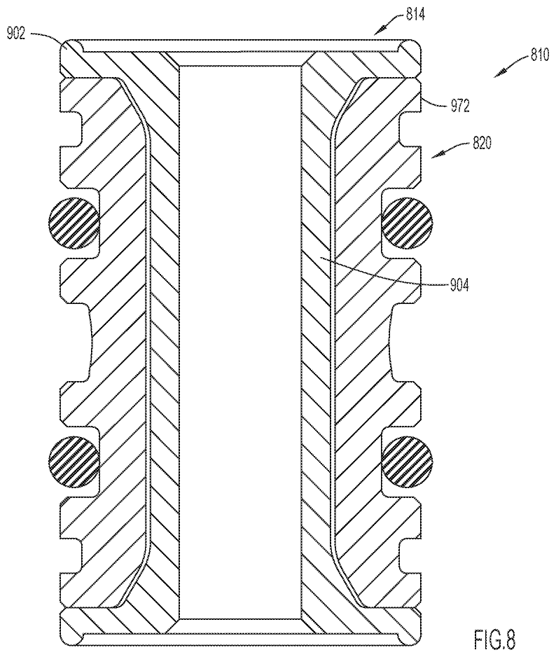

FIG. 8 is a cross-sectional view of a further pinch valve subassembly 810 having a diaphragm 814 secured within a cage 820, such as via flanges 902. In the illustrated embodiment, the flanges 902 extend to an outer edge 972 of the cage 820. Such an extension of the flanges 902 increases a size of the flange 902 and can therefore increase a structural strength of the flanges 902. For example, the flanges 902 can impart a greater force onto the cage 820. Consequently, the flanges 902 can maintain its sealed engagement with the cage 820, such as by withstanding relatively higher pressures that are imparted by working fluid between a main body 904 of the diaphragm 814 and the cage 820 while the diaphragm 814 is deformed (e.g., the diaphragm 814 is compressed inward away from the cage 820). Thus, the flanges 902 can help maintain coupling of the diaphragm 814 and the cage 820 to one another and to direct working fluid onto the diaphragm 814.

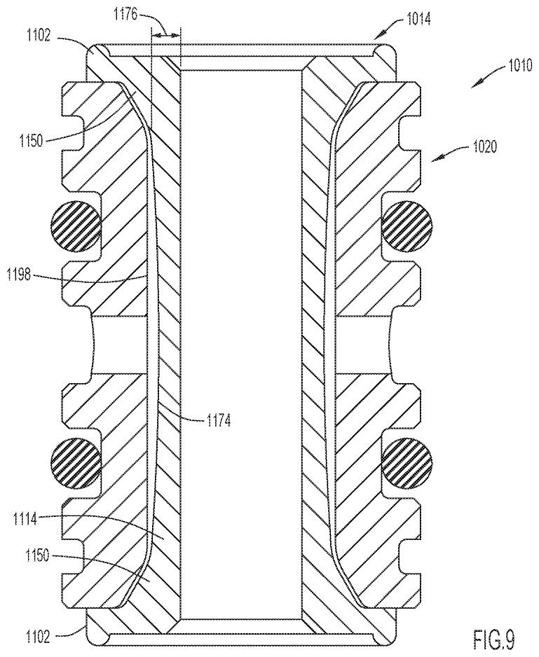

FIG. 9 is a cross-sectional view of yet another pinch valve subassembly 1010 having a diaphragm 1014 secured within a cage 1020, such as via flanges 1102. The illustrated diaphragm 1014 includes a main body 1114 with tapered walls 1174. For example, the diaphragm 1014 includes tapered portions 1150 extending from the flanges 1102, and the tapered walls 1174 extend between the tapered portions 1150. The tapered walls 1174 extend inwardly away from the cage 1020, thereby providing a space 1198 between the main body 1114 and the cage 1020 even while no working fluid is directed onto and compressing the main body 1114. However, the flanges 1102 remain sealingly engaged with the cage 1020 to block undesirable working fluid flow between the flanges 1102 and the cage 1020 (e.g., instead of against the main body 1114). The tapered walls 1174 reduce a thickness 1176 of the main body 1114. The reduced thickness 1176 of the main body 1114 may reduce the amount of force that can be imparted to deform (e.g., compress) the main body 1114. By way of example, a relatively lower amount of pressure from working fluid can be provided to close the diaphragm 1014. Accordingly, the thickness of the main body 1114 can be configured (e.g., by changing a shape of the tapered walls 1174) to change an amount of pressure used to close the pinch valve subassembly 1010 (e.g., relative to the pressure of working fluid flowing through the diaphragm 1014). For example, a pinch valve subassembly 1010 with a diaphragm 1014 having a particular thickness 1176 can be selected and/or manufactured to enable a target pressure of working fluid to close the pinch valve subassembly 1010.

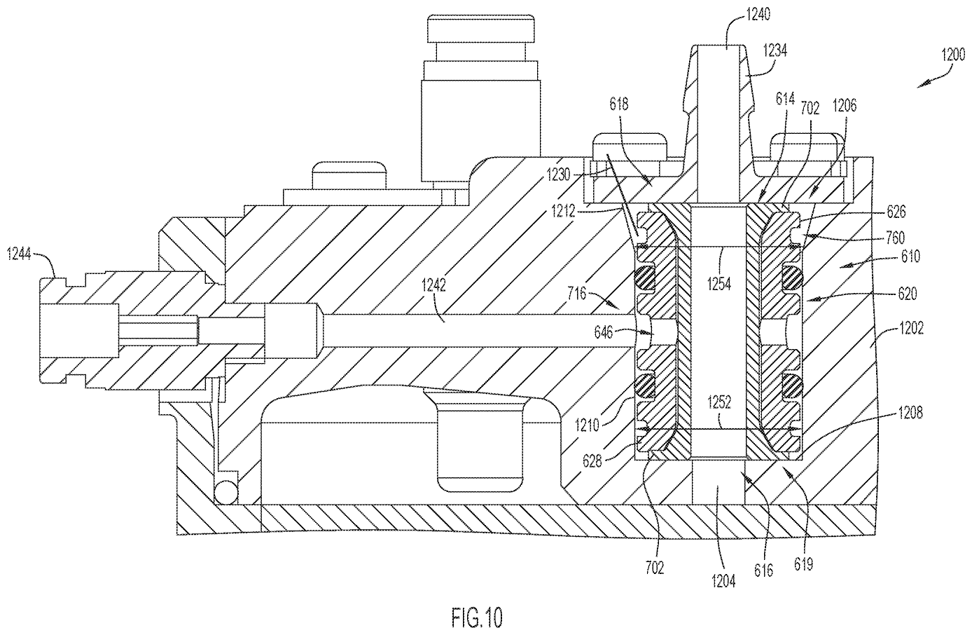

FIG. 10 is a cross-sectional view of the pinch valve subassembly 610 positioned in a conduit system 1200. However, it should be noted that the usage of the pinch valve subassembly 610 is merely provided as an example and that any of the pinch valve subassemblies discussed herein can be incorporated in the conduit system 1200. The conduit system 1200 includes a housing 1202 that contains a conduit 1204, as well as a cavity 1206 fluidically coupled to the conduit 1204 such that the conduit 1204 can receive process fluid from and/or discharge process fluid to the cavity 1206. The pinch valve subassembly 610 is insertable into the cavity 1206 and can fluidically couple to the conduit 1204 in an installed configuration such that one of the flanges 702 of the diaphragm 614 abuts a back surface 1208 of the housing 1202. In addition, a cap or connector 1234 is configured to couple to the housing 1202, extend over the cavity 1206, and abut the other of the flanges 702 of the diaphragm 614. The cap 1234 defines an opening 1240 that is fluidically coupled to the opening 616 to enable process fluid flow between the pinch valve subassembly 610 and the cap 1234 in the installed configuration of the pinch valve subassembly 610.

In the installed configuration, the opening 616 of the pinch valve subassembly 610 overlaps with (e.g., concentrically aligns with) the conduit 1204 to enable process fluid flow between the conduit 1204 and the diaphragm 614. Additionally, the housing 1202 defines a working fluid line 1242, and the conduit system 1200 includes a working fluid source 1244 fluidically coupled to the working fluid line 1242. In the installed configuration, the opening 646 and the cavity 716 are fluidically coupled to the working fluid line 1242, thereby enabling the working fluid source 1244 to output working fluid through the working fluid line 1242, into the opening 646, and against the diaphragm 614 to compress the diaphragm 614 and close the pinch valve subassembly 610.

As discussed, either cage end 626, 628 can be the leading end that is initially inserted into the cavity 1206. For example, the housing 1202 includes first internal walls 1210 at the cavity 1206 that span a first distance 1252 away from one another, and the first distance 1252 can accommodate a size of both the first cage end 626 and the second cage end 628. Thus, either of the first cage end 626 and the second cage end 628 can be initially inserted into the cavity 1206 to be positioned between the first internal walls 1210. As such, even though the second cage end 628 is the leading end and the first cage end 626 is the trailing end in the illustrated conduit system 1200 such that a first diaphragm end 618 of the diaphragm 614 abuts the cap 1234 and a second diaphragm end 619 abuts the back surface 1208, in an alternative embodiment, the first cage end 626 can be the leading end and the second cage end 628 can be the trailing end such that the second diaphragm end 619 abuts the cap 1234 and the first diaphragm end 618 abuts the back surface 1208. In either case, the working fluid source 1244 is configured to direct working fluid to control opening and closing of the pinch valve subassembly 610. As such, the pinch valve subassembly 610 facilitates an ease of installation in the housing 1202 without affecting operation of the conduit system 1200.

The housing 1202 further includes second internal walls 1212 extending and tapering radially outward from the first internal walls 1210 at the cavity 1206. As such, a second distance 1254 spanning between the second internal walls 1212 is greater than the first distance 1252 spanning between the first internal walls 1210. The second internal walls 1212 can facilitate an ease of installation and/or an ease of removal of the pinch valve subassembly 610 with respect to the cavity 1206. By way of example, in the installed configuration of the pinch valve subassembly 610, the pinch valve subassembly 610 extends between the second internal walls 1212 to provide a gap between the cage 620 (e.g., the first cage end 626) and the second internal walls to increase accessibility of the groove 760. For instance, a tool 1230, such as a screwdriver and/or a hook, can extend through the gap and into the groove 760. The tool 1230 can then contact the cage 620 while positioned within the groove 760 to be used as a lever to move the pinch valve subassembly 610 relative to the housing 1202 and remove the pinch valve subassembly 610 from the cavity 1206. Similarly, the tool 1230 can also be used to move the pinch valve subassembly 610 relative to the housing 1202 to position the pinch valve subassembly 610 within the cavity 1206. By enabling usage of the tool 1230 to move the pinch valve subassembly 610 relative to the housing 1202, the groove 760 and the second internal walls 1212 enable the pinch valve subassembly 610 to be more readily removed from and/or installed into the cavity 1206.

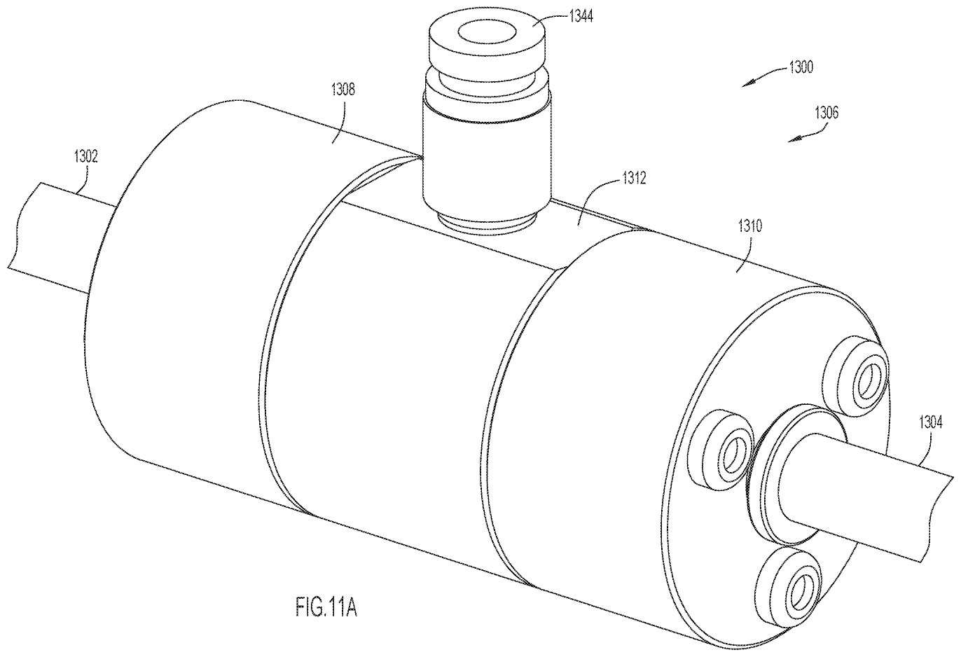

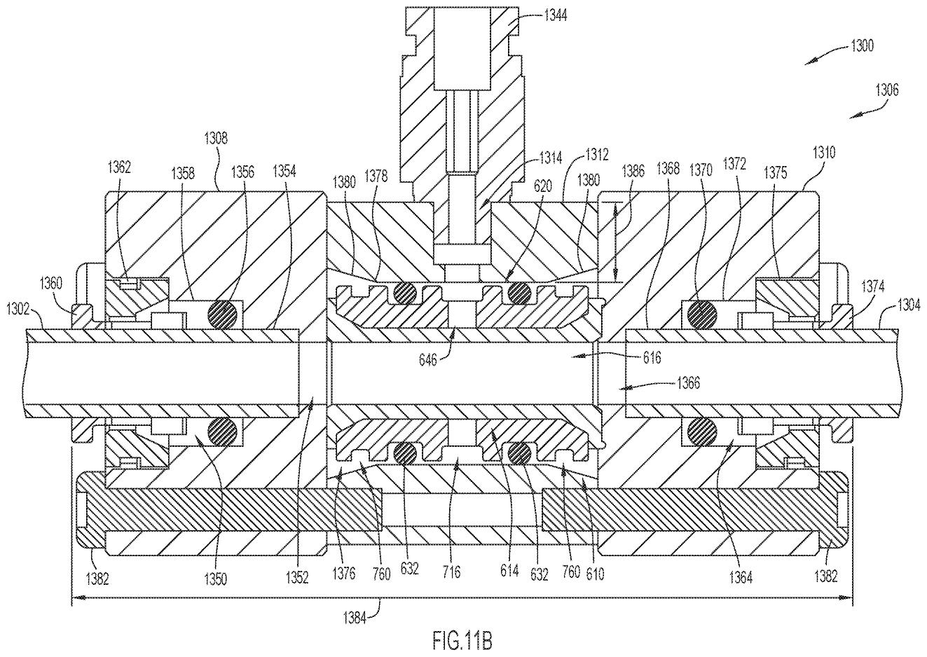

FIG. 11A is a perspective view of a conduit system 1300 (e.g., an inline conduit system) in which aspects of the techniques presented herein can be implemented. The conduit system 1300 includes a first conduit 1302 (e.g., an inlet conduit), a second conduit 1304 (e.g., an outlet conduit), and an intermediate assembly 1306. The intermediate assembly 1306 is configured to direct fluid between the first conduit 1302 and the second conduit 1304. For example, the conduit system 1300 directs process fluid from the first conduit 1302, through the intermediate assembly 1306, and into the second conduit 1304.

The intermediate assembly 1306 includes a first adapter, connector, or cartridge 1308 configured to couple to the first conduit 1302, a second adapter, connector, or cartridge 1310 configured to couple to the second conduit 1304, and a pinch valve housing or enclosure 1312 configured to couple to the first adapter 1308 and to the second adapter 1310. In this way, the first adapter 1308, the second adapter 1310, and the pinch valve enclosure 1312 cooperatively couple the first conduit 1302 and the second conduit 1304 to one another to direct process fluid therethrough. The pinch valve enclosure 1312 is configured to receive and secure a pinch valve subassembly (not shown), such as any of the pinch valve subassembly embodiments discussed herein. As such, the pinch valve enclosure 1312 directs fluid between the first adapter 1308 and the second adapter 1310 via the pinch valve subassembly. Although the illustrated first adapter 1308, the second adapter 1310, and the pinch valve enclosure 1312 have cylindrical shapes, the first adapter 1308, the second adapter 1310, and the pinch valve enclosure 1312 can have any other suitable shape (e.g., a rectangular prismatic shape) in alternative embodiments.

The pinch valve enclosure 1312 is also configured to couple to a working fluid source 1344. The working fluid source 1344 is configured to direct working fluid into the pinch valve enclosure 1312 to close the pinch valve subassembly. Thus, the working fluid source operates to control process fluid flow through the intermediate assembly 1306 and therefore between the first conduit 1302 and the second conduit 1304.

FIG. 11B is a cross-sectional view of the conduit system 1300 that includes the first conduit 1302, the second conduit 1304, and the intermediate assembly 1306. The first adapter 1308 includes a first cavity 1350 and a first opening 1352 fluidically coupled to one another. The first conduit 1302 extends into the first cavity 1350 and abuts first internal walls 1354 of the first adapter 1308 to fluidically couple to the first opening 1352. A first seal 1356 (e.g., an O-ring) extends around the first conduit 1302 and abuts the first conduit 1302 and second internal walls 1358 of the first adapter 1308 to secure the first conduit 1302 within the first cavity 1350. A first retainer or collar 1360 surrounding the first conduit 1302 extends into the first cavity 1350 and abuts third internal walls 1362 of the first adapter 1308 to further secure the first conduit 1302 within the first cavity 1350. Similarly, the second adapter 1310 includes a second cavity 1364 and a second opening 1366 fluidically coupled to one another. The second conduit 1304 extends into the second cavity 1364 and abuts first internal walls 1368 of the second adapter 1310 to fluidically couple to the second opening 1366. A second seal 1370 (e.g., an O-ring) extends around the second conduit 1304 and abuts the second conduit 1304 and second internal walls 1372 of the second adapter 1310 to secure the second conduit 1304 within the second cavity 1364. A second retainer or collar 1374 surrounding the second conduit 1304 extends into the second cavity 1364 and abuts third internal walls 1375 of the second adapter 1310 to further secure the second conduit 1304 within the second cavity 1364. Although the illustrated adapters 1308, 1310 have similar features in the illustrated conduit system 1300, it should be noted that adapters having different features can be implemented in additional or alternative embodiments to couple to the conduits 1302, 1304. Indeed, any suitable component, such as a clamp, can be used to couple the conduits 1302, 1304 to one another and to the pinch valve enclosure 1312.

The pinch valve enclosure 1312 includes a chamber 1376. In the illustrated embodiment, the pinch valve subassembly 610 is positioned in the chamber 1376, but any of the pinch valve subassemblies discussed herein can be disposed in the chamber 1376 in alternative embodiments. Positioning the pinch valve subassembly 610 in the chamber 1376 aligns the opening 616 of the pinch valve subassembly 610 with the first opening 1352 of the first adapter 1308 and with the second opening 1366 of the second adapter 1310, thereby fluidically coupling the pinch valve subassembly 610 to the conduits 1302, 1304 that are fluidically coupled to the first opening 1352 and the second opening 1366, respectively. Therefore, process fluid can flow through the conduit system 1300 via the first conduit 1302, the first opening 1352 of the first adapter 1308, the opening 616 of the pinch valve subassembly 610, the second opening 1366 of the second adapter 1310, and the second conduit 1304. Furthermore, the pinch valve enclosure 1312 includes a channel 1314 extending to the chamber 1376 and configured to receive the working fluid source 1344. While the pinch valve subassembly 610 is positioned in the chamber 1376, the opening 646 of the pinch valve subassembly 610 is configured to fluidically couple to the channel 1314 (e.g., via the cavity 716). As a result, the pinch valve subassembly 610 is configured to fluidically couple to the working fluid source 1344 positioned in the channel 1314. For example, the working fluid source 1344 is configured to direct working fluid through the channel 1314, through the chamber 1376, through the opening 646, and against the diaphragm 614 to close the pinch valve subassembly 610, thereby controlling process fluid flow through the conduit system 1300.

The seals 632 of the pinch valve subassembly 610 are configured to abut first internal walls 1378 of the pinch valve enclosure 1312 to block excessive working fluid flow between the first internal walls 1378 of the pinch valve enclosure 1312 and the cage 620 of the pinch valve subassembly 610. As such, the seals 632 urge working fluid flow from the chamber 1376 into the opening 646 to facilitate closure of the pinch valve subassembly 610. Additionally, the pinch valve enclosure 1312 includes second internal walls 1380 extending and tapering radially outward from the internal walls 1378 of the pinch valve enclosure 1312 at the chamber 1376. For instance, the grooves 760 of the pinch valve subassembly 610 are positioned between the second internal walls 1380, and a gap is formed between the cage 620 and the second internal walls 1380 to provide access to the grooves 760. As such, a tool (e.g., the tool 1230) can be inserted into the grooves 760 to facilitate removal of the pinch valve subassembly 610 from and/or installation of the pinch valve subassembly 610 within the chamber 1376 of the pinch valve enclosure 1312.

The illustrated adapters 1308, 1310 are configured to couple to the pinch valve enclosure 1312 using respective fasteners 1382. That is, the fasteners 1382 extend through the first adapter 1308 and into the pinch valve enclosure 1312 to mount the first adapter 1308 to the pinch valve enclosure 1312 or through the second adapter 1310 and into the pinch valve enclosure 1312 to mount the second adapter 1310 to the pinch valve enclosure 1312. However, another component, such as a clamp, an adhesive, a weld, a latch, and the like, can be used in additional to or as an alternative to the fasteners 1382 to couple the adapters 1308, 1310 and the pinch valve enclosure 1312 to one another.

It should be noted that the intermediate assembly 1306 can be readily (e.g., manually) implemented into and removed from the conduit system 1300. For example, the conduits 1302, 1304 can be readily coupled to and removed from the adapters 1308, 1310, respectively, via the seals 1356, 1370 and/or the retainers 1360, 1370. Therefore, the intermediate assembly 1306 can facilitate an ease of modification of the conduit system 1300, such as for selectively incorporating the intermediate assembly 1306 at a particular location (e.g., to couple to particular conduits 1302, 1304). Moreover, the intermediate assembly 1306 occupies a limited physical footprint. For example, a first dimension 1384 (e.g., a length) of the intermediate assembly 1306 can be less than 100 millimeters (mm), such as a value between 40 mm and 60 mm, and a thickness 1386 of the pinch valve enclosure 1312 can be less than 5 mm, such as a value between 3 mm and 4 mm. The compact size of the intermediate assembly 1306 can facilitate ease of transportation of the intermediate assembly 1306. Additionally, implementing the intermediate assembly 1306 in the conduit system 1300 does not significantly increase an overall size of the conduit system 1300, thereby enabling flexible usage of the conduit system 1300 in desirable implementations.

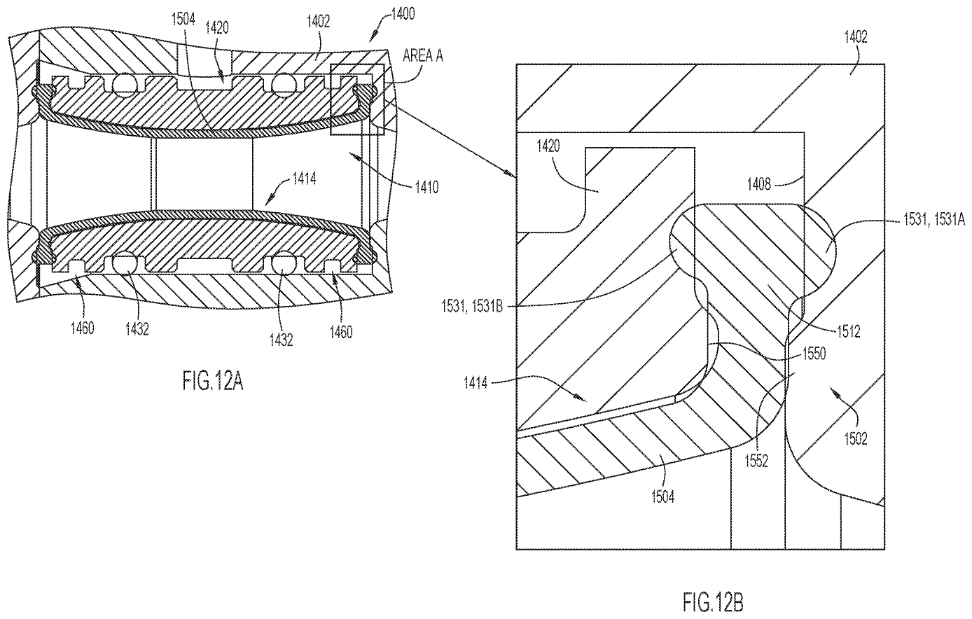

FIG. 12A is a cross-sectional side view of another conduit system 1400 in which aspects of the techniques presented herein can be implemented. FIG. 12B is a detailed view of “Area A” of FIG. 12A. FIGS. 12A and 12B will be discussed with one another for ease of description.

As shown, the conduit system 1400 comprises a pinch valve subassembly 1410, which includes a diaphragm 1414 and a cage 1420 surrounding a main body 1504 of the diaphragm 1414. The pinch valve subassembly 1410 is positioned in a housing 1402 of the conduit system 1400. In the illustrated example, the pinch valve subassembly 1410 includes similar features as that of the pinch valve subassembly 620, such as multiple seals 1432 and multiple recesses 1460, but in additional or alternative embodiments, the pinch valve subassembly 1410 includes similar features as that of the pinch valve subassembly 110. In any case, the diaphragm 1414 and/or the cage 1420 includes features to facilitate securement to one another and/or to the housing 1402 of the conduit system 1400.

As noted, the detailed view of FIG. 12B provides greater visualization of Area A of the pinch valve subassembly 1410. As illustrated in FIG. 12B, a flange 1502 of the diaphragm 1410 includes a base portion 1512, a first raised sealing ring 1531A (first raised portion) extending from the base portion 152 away from the cage 1420 (e.g., in a longitudinal direction), such as toward a back surface 1408 of the housing 1402, and a second raised sealing ring 1531B (second raised portion) extending from the base portion 1512 toward the cage 1420 (e.g., in a longitudinal direction). For example, in an installed configuration of the pinch valve subassembly 1410, the first raised sealing ring 1531A is configured to abut the back surface 1408 to reduce relative movement of the diaphragm 1414 with respect to the housing 1402, and the second raised sealing ring 1531B is configured to abut the cage 1420 to reduce relative movement of the diaphragm 1414 with respect to the cage 1420. Thus, the raised sealing rings 1531 cooperatively secure the diaphragm 1414 and the pinch valve subassembly 1410 within the housing 1402. In some embodiments, each of the raised sealing rings 1531 includes an arcuate (e.g., half circular) shape, but the raised sealing rings 1531 can have any suitable shape (e.g., wave or ridged profiles, corners) in additional or alternative embodiments.

Moreover, the back surface 1408 of the housing 1402 includes a lip 1552 extending toward and abutting the flange 1502 between the first raised sealing ring 1531A and the main body 1504 of the diaphragm 1414, and the cage 1420 (e.g., an end of the cage 1420) includes a bump 1550 extending toward and abutting the flange 1502 of the diaphragm 1414 between the second raised sealing ring 1531B and the main body 1504 of the diaphragm 1414. Thus, the bump 1550 of the cage 1420 and the lip 1552 of the housing 1402 extend into contact and abutment with (e.g., compress against) the flange 1502 of the diaphragm 1414 to create a smaller passageway through which the flange 1502 extends between the cage 1420 and the housing 1402. The smaller passageway helps block movement of the diaphragm 1414 with respect to the cage 1420 and with respect to the housing 1402. Thus, the diaphragm 1414 and the pinch valve subassembly 1400 are further secured within the housing 1402. In this manner, the contoured (e.g., stepped) profiles of the diaphragm 1414, the cage 1420, and the housing 1402 cooperatively promote contact between the diaphragm 1414, the cage 1420, and the housing 1402 to secure the pinch valve subassembly 1400 within the housing 1402. For example, the bump 1550 of the cage 1420 and the lip 1552 of the housing 1402 block the flange 1502 (e.g., the base portion 1512) from sliding toward the main body 1504 of the diaphragm 1414, such as while fluid is directed against the main body 1504 of the diaphragm 1414 to compress the main body 1504. Consequently, the flange 1502 maintains contact with the cage 1420 and with the housing 1402.

In additional or alternative embodiments, similar features discussed with respect to the flange 1502 configured to engage the back surface 1408 of the housing 1402 are incorporated into the flange 1502 configured to engage a cap coupled to the housing 1402. That is, such a flange 1502 includes a base portion, a first raised sealing ring that extends from the base portion away from the cage and toward the cap, and a second raised sealing ring that extends from the base portion toward the cage. Thus, the first raised sealing ring reduces relative movement of the diaphragm 1414 with respect to the cap and the second raised sealing ring reduces relative movement of the diaphragm 1414 with respect to the cage 1420 to cooperatively secure the diaphragm 1414 and the pinch valve subassembly 1410 within the housing 1402. Furthermore, the cap can include a similar bump as that of the cage 1420 in that the bump extends toward and abuts the flange 1502 between the second raised sealing ring and the main body 1504 of the diaphragm to help block movement of the diaphragm 1414 with respect to the cap. Further still, it should be noted that any combination of such features can be independently and separately implemented in the pinch valve subassembly 1410. As an example, any of the flanges 1502 can include a raised sealing ring (e.g., the second raised sealing ring 1531B) that extends toward the cage 1420 and not a raised sealing ring (e.g., the first raised sealing ring 1531A) that extends away from the cage 1420. As another example, a single one of the back surface 1408 or the cage 1420 can include the lip 1552 or the bump 1550, respectively.

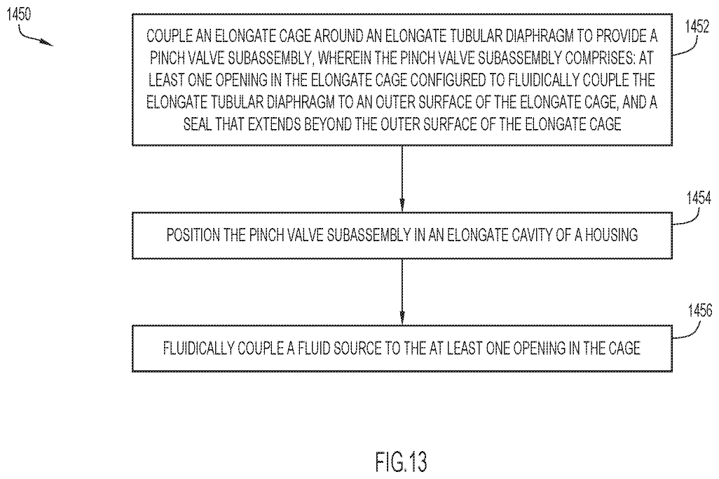

FIG. 13 is a flowchart of a method 1450 of manufacture of a conduit system, such as any of the conduit systems 100, 150, 200, 500, 1200, 1300, 1400 discussed herein. By way of example, the operations of the method 1450 can be manually performed by a user, such as a technician, an operator, and/or a manufacturer. It should be noted that the method 1450 can be performed in a different manner in additional or alternative embodiments. For instance, additional operations can be performed with respect to the described method 1450. Additionally or alternatively, certain steps of the depicted method 1450 can be removed, modified, and/or performed in a different order.

At block 1452, an elongate cage is coupled around an elongate tubular diaphragm to provide a pinch valve subassembly. The pinch valve subassembly comprises: at least one opening configured to fluidically couple the elongate tubular diaphragm to an outer surface of the elongate cage, at least one circumferential recess in the outer surface of the cage, and an O-ring disposed in the at least one circumferential recess. In one example, the elongate cage has a hole, and the elongate tubular diaphragm is inserted into one of the ends of the elongate cage and pulled through the hole to an opposing end of the cage to extend between the ends of the cage along a longitudinal axis. As a result, the elongate cage is disposed around the elongate tubular diaphragm in a sealing engagement such that an inner surface of the elongate cage is disposed around and faces a portion (e.g., a main body) of the elongate tubular diaphragm. The at least one opening of the pinch valve subassembly extends from the outer surface of the elongate cage to the inner surface of the elongate cage in a direction transverse to the longitudinal axis to extend to the hole of the elongate cage and expose the portion of the elongate tubular diaphragm disposed within the hole. In one arrangement, the elongate cage places the elongate tubular diaphragm in longitudinal tension upon coupling to the diaphragm. For instance, the elongate cage ends impart forces onto the respective diaphragm ends to stretch the diaphragm ends away from one another.

At block 1454, the pinch valve subassembly is positioned in an elongate cylindrical cavity of a housing. For instance, the pinch valve subassembly is inserted into the cavity to abut one of the diaphragm ends against a back surface of the housing. A seal coupled to the cage engages interior housing walls of the housing to secure the position of the pinch valve subassembly within the cavity. In some embodiments, the elongate cylindrical cavity includes a longitudinal axis, and the pinch valve subassembly is inserted into the elongate cylindrical cavity in any rotational orientation about the longitudinal axis, and wherein the diaphragm of the pinch valve subassembly is exposed to the fluid line in any of the rotational orientations about the longitudinal axis via a circumferential cavity extending around the diaphragm and fluidically coupled to the at least one opening of the diaphragm.

At block 1456, a working fluid source is fluidically coupled to the at least one opening in the cage, thereby enabling the working fluid source to output working fluid flow against the portion of the diaphragm exposed by the at least one opening to transition the pinch valve subassembly to a closed configuration. In certain examples, a cap is coupled to the housing to cover the cavity, and the cap engages against the diaphragm. Accordingly, the cap compresses the pinch valve subassembly against the back surface, further securing the pinch valve subassembly within the cavity.

Certain aspects of the techniques presented herein have been described with reference to various descriptions of fluid dynamics. It is to be appreciated that these various descriptions are provided for purposes of illustration and that the innovation presented herein works regardless of the believed understanding of the fluid dynamics.

As should be appreciated, while particular uses of the technology have been illustrated and discussed above, the disclosed technology can be used with a variety of devices in accordance with many examples of the technology. The above discussion is not meant to suggest that the disclosed technology is only suitable for implementation within systems akin to that illustrated in the figures. In general, additional configurations can be used to practice the processes and systems herein and/or some aspects described can be excluded without departing from the processes and systems disclosed herein.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., portions, components) described with respect to the figures herein are not intended to limit the systems and processes to the particular aspects described. Accordingly, additional configurations can be used to practice the methods and systems herein and/or some aspects described can be excluded without departing from the methods and systems disclosed herein.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

It is also to be appreciated that the embodiments presented herein are not mutually exclusive and that the various embodiments can be combined with another in any of a number of different manners. That is, it is believed that the disclosure set forth above encompasses multiple distinct embodiments with independent utility. While each of these embodiments has been disclosed in a preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions, and/or properties disclosed herein. Accordingly, it is appropriate that the appended claims be construed broadly and in a manner consistent with the scope of the disclosure as set forth in the following claims.

It is also to be understood that terms such as “left,” “right,” “top,” “bottom,” “front,” “rear,” “side,” “height,” “length,” “width,” “upper,” “lower,” “interior,” “exterior,” “inner,” “outer” and the like as can be used herein, merely describe points of reference and do not limit the present disclosure to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the disclosure. Additionally, it is also to be understood that the consumables described herein, or portions thereof can be fabricated from any suitable material or combination of materials, such as plastic or metals, as well as derivatives thereof, and combinations thereof.

Finally, when used herein, the term “comprises” and its derivations (such as “comprising”, etc.) should not be understood in an excluding sense, that is, these terms should not be interpreted as excluding the possibility that what is described and defined can include further elements, steps, etc. Similarly, where any description recites “a” or “a first” element or the equivalent thereof, such disclosure should be understood to include incorporation of one or more such elements, neither requiring nor excluding two or more such elements. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc.). For example, the term “approximately” can denote a tolerance of plus or minus 0.002 inches, 0.001 inches, or up to 0.005 inches. The same applies to the terms “about” and “around” and “substantially.” Moreover, for the purposes of the present disclosure, the phrase “A and/or B” means (A), (B), or (A and B), and the phrase “A, B, and/or C” means (A), (B), (C), (A and B), (A and C), (B and C), or (A, B and C).

1. A pinch valve subassembly, comprising:
an elongate tubular diaphragm comprising a main body;
an elongate cage comprising an inner surface configured to be disposed around and face the main body of the elongate tubular diaphragm in a sealing engagement with the elongate tubular diaphragm, wherein the elongate cage has a first end, a second end, and at least one opening extending from an outer surface of the elongate cage between the first end and the second end to the inner surface of the elongate cage; and
a seal disposed between the first end and the at least one opening.

2. The pinch valve subassembly of claim 1, wherein the elongate cage includes a circumferential recess disposed between the first end and the at least one opening, and wherein the seal is disposed within the circumferential recess.

3. The pinch valve subassembly of claim 1, wherein the seal comprises an O-ring.

4. The pinch valve subassembly of claim 1, wherein the elongate cage includes a circumferential pneumatic cavity, and wherein the at least one opening in the elongate cage is disposed in the circumferential pneumatic cavity.

5. The pinch valve subassembly of claim 1, wherein the elongate cage is configured to place the elongate tubular diaphragm in longitudinal tension in a coupled configuration to sealingly engage the elongate tubular diaphragm.

6. The pinch valve subassembly of claim 1, wherein the elongate cage further comprises a circumferential groove between the seal and the first end.

7. The pinch valve subassembly of claim 1, wherein the tubular diaphragm comprises a flange configured to contact the first end of the elongate cage, and the flange includes a raised sealing ring extending longitudinally from a base of the flange.

8. The pinch valve subassembly of claim 7, wherein the tubular diaphragm comprises an additional flange configured to contact the second end of the elongate cage, the additional flange includes an additional raised sealing ring extending longitudinally from an additional base of the additional flange, and the raised sealing ring and the additional raised sealing ring extend away from one another.

9. A conduit system comprising the pinch valve subassembly of claim 1 and including:
a housing comprising interior walls defining an elongate cavity with a longitudinal axis,
wherein the pinch valve subassembly is configured to be installed in the elongate cavity in multiple different orientations that are rotationally offset from one another about the longitudinal axis, and the at least one opening in the elongate cage is configured to receive working fluid from a fluid source via the outer surface of the elongate cage in each of the different orientations that are rotationally offset from one another about the longitudinal axis.

10. The conduit system of claim 9, wherein the housing comprises additional interior walls extending from the interior walls, wherein the interior walls and the additional interior walls cooperatively define the elongate cavity, wherein a first distance spans between the interior walls, wherein a second distance spans between the additional interior walls, and wherein the second distance is greater than the first distance.

11. The conduit system of claim 10, wherein the elongate cage of the pinch valve subassembly further comprises a groove adjacent to the first end, and wherein the groove is positioned between the additional interior walls in an installed configuration of the pinch valve subassembly.

12. The conduit system of claim 10, wherein the second end of the elongate cage is configured to engage an end of the elongate tubular diaphragm, wherein the housing comprises a back surface extending from the interior walls, wherein the end of the elongate tubular diaphragm is configured to engage the back surface in an installed configuration of the pinch valve subassembly.

13. The conduit system of claim 12, comprising a cap configured to couple to the housing and extend over the elongate cavity, wherein the cap is configured to engage an additional end of the elongate tubular diaphragm.

14. The conduit system of claim 9, wherein the seal of the pinch valve subassembly is configured to engage the interior walls in an installed configuration of the pinch valve subassembly.

15. The conduit system of claim 9, wherein the elongate cavity includes a cylindrical profile.

16. The pinch valve subassembly of claim 1, further comprising an additional seal disposed between the second end and the at least one opening.

17. The pinch valve subassembly of claim 16, wherein the at least one opening is positioned equidistant to the seal and the additional seal.

18-28. (canceled)

29. A method of manufacturing a conduit system, comprising:
coupling an elongate cage around an exterior surface of a main body of an elongate tubular diaphragm to provide a pinch valve subassembly, wherein the pinch valve subassembly comprises at least one opening in the elongate cage exposing the exterior surface of the main body of the elongate tubular diaphragm to fluidically couple the exterior surface of the main body of the elongate tubular diaphragm to an outer surface of the elongate cage, and wherein the pinch valve subassembly comprises a seal that extends beyond the outer surface of the elongate cage;
positioning the pinch valve subassembly in an elongate cavity of a housing; and
fluidically coupling a fluid source to the at least one opening in the elongate cage.

30. The method of claim 29, wherein the elongate cavity includes a longitudinal axis, and wherein positioning the pinch valve subassembly in the elongate cavity comprises:
inserting the pinch valve subassembly into the elongate cavity, wherein the pinch valve subassembly is operable to be inserted into the elongate cavity in at least a plurality of rotational orientations about the longitudinal axis, and wherein the elongate tubular diaphragm of the pinch valve subassembly is exposed to a fluid line fluidically connected to the fluid source in each of the plurality of rotational orientations about the longitudinal axis.

31. (canceled)

32. (canceled)

33. The method of claim 29, wherein coupling the elongate cage around the elongate tubular diaphragm comprises:
inserting the elongate tubular diaphragm into a first end of the elongate cage; and
pulling the elongate tubular diaphragm through a second end of the elongate cage, wherein the first end of the elongate cage and the second end of the elongate cage stretch respective ends of the elongate tubular diaphragm to place the elongate tubular diaphragm in longitudinal tension.
